(19) United States
(12) Patent Application Publication
(10) Pub. No.: US 2011/0317762 A1
(43) Pub. Date: Dec. 29, 2011

(54) VIDEO ENCODER AND PACKETIZER WITH IMPROVED BANDWIDTH UTILIZATION

(75) Inventor: Jagadeesh SANKARAN, Allen, TX (US)

(73) Assignee: TEXAS INSTRUMENTS INCORPORATED, Dallas, TX (US)

(21) Appl. No.: 12/825,470

(22) Filed: Jun. 29, 2010

(51) Int. Cl. H04N 7/32; H04L 12/56; H04N 7/26

(52) U.S. Cl. 375/240.13; 375/240.24; 375/240.12; 375/240.16; 370/474; 370/477; 375/E07.123; 375/E07.243

(57) ABSTRACT

Techniques for managing a video encoding pipeline are disclosed herein. In one embodiment, a video encoder includes a multi-stage encoding pipeline. The pipeline includes an entropy coding engine and a transform engine. The entropy encoding engine is configured to, in a first pipeline cycle, entropy encode a transformed first macroblock and determine that a predetermined slice size will be exceeded by adding the entropy encoded macroblock to a slice. The transform engine is configured to provide a transformed macroblock to the entropy coding engine. The transform engine is also configured to determine, in a third pipeline cycle, coding and prediction mode to apply to the first macroblock, based on the entropy coding engine determining, in the first pipeline cycle, that the predetermined slice size will be exceeded by adding the encoded macroblock to a slice.

### BACKGROUND

The H.241 recommendation promulgated by the International Telecommunication Union (“ITU”) specifies packetization of video bitstreams. The H.241 recommendation can be applied to a video bitstream encoded according to the H.264 standard also promulgated by the ITU. Applying H.241 to an H.264 video bitstream requires that each output packet include an integer number of macroblocks. Additionally, each fixed size output packet should contain as many macroblocks as possible.

The number of bits in an H.264 encoded macroblock can be determined only after the macroblock is fully encoded. Therefore, whether a packet can contain a macroblock is determinable only after the macroblock is encoded. However, macroblock encoding is restricted based on the contents of the packet in which the macroblock is inserted. Consequently, packetization via application of H.241 may affect operation of an H.264 video encoding pipeline.

### SUMMARY

Techniques for managing a video encoding pipeline are disclosed herein. In one embodiment, a video encoder includes a multi-stage encoding pipeline. The pipeline includes an entropy coding engine and a transform engine. The entropy coding engine is configured to, in a first pipeline cycle, entropy encode a transformed first macroblock and determine that a predetermined maximum slice size will be exceeded by adding the entropy encoded macroblock to a slice. The transform engine is configured to provide a transformed macroblock to the entropy coding engine. The transform engine is also configured to determine, in a third pipeline cycle, coding and prediction mode to apply to the first macroblock, based on the entropy coding engine determining, in the first pipeline cycle, that the predetermined maximum slice size will be exceeded by adding the encoded macroblock to the slice.

In another embodiment, a method includes applying, by processing circuitry, entropy coding to a transformed first macroblock in a first pipeline cycle. In the first pipeline cycle, the processor determines that a predetermined maximum slice size will be exceeded by adding the entropy encoded macroblock to a slice. In a third pipeline cycle, a processor determines a coding and prediction mode to apply to the first macroblock, based on the determining in the first pipeline cycle. The first macroblock is retransformed using the coding and prediction mode.

In a further embodiment, a computer readable medium is encoded with a computer program. When executed, the program causes processing circuitry to apply entropy coding to a transformed first macroblock in a first pipeline cycle. The program also causes processing circuitry to determine, in the first pipeline cycle, that a predetermined maximum slice size will be exceeded by adding the entropy encoded macroblock to a slice. The program further causes processing circuitry to determine, in a third pipeline cycle, a coding and prediction mode to apply to the first macroblock, based on the determining in the first pipeline cycle. The program yet further causes processing circuitry to retransform the first macroblock using the coding and prediction mode.

In a yet further embodiment, a video system includes a video encoder that encodes video data and a packetizer that divides encoded video data into packets. The packetizer is configured to receive a first entropy encoded macroblock, and determine, in a first encoder pipeline cycle, whether a predetermined maximum packet size will be exceeded by adding the first entropy encoded macroblock to a first packet. The video encoder includes a transform engine pipeline stage and an entropy encoder pipeline stage. The transform engine pipeline stage is configured to determine, in a third encoder pipeline cycle, coding and prediction mode to apply to the first macroblock, based on the packetizer determining, in the first pipeline cycle, that the predetermined maximum packet size will be exceeded by adding the first entropy encoded macroblock to the first packet. The entropy encoder pipeline stage is configured to entropy encode a transformed macroblock produced by the transform engine, and provide the entropy encoded macroblock to the packetizer.

### BRIEF DESCRIPTION OF THE DRAWINGS

For a detailed description of exemplary embodiments of the invention, reference will now be made to the accompanying drawings in which:

FIG. 1 shows a block diagram of a video encoding system in accordance with various embodiments;

FIG. 2 shows a block diagram of pipeline stages of a video encoder in accordance with various embodiments;

FIG. 3 shows a block diagram of pipeline stages and memory buffers of a video encoder in accordance with various embodiments;

FIG. 4 shows operations of a video encoder pipeline responsive to a slice break condition in accordance with various embodiments;

FIG. 5 shows a block diagram of a processor based system for encoding video in accordance with various embodiments; and

FIG. 6 shows a flow diagram for a method of encoding video responsive to a slice break condition in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software.

The term “pipeline cycle” is intended to mean the time interval required to process a data value in a pipeline stage. For example, data A is processed in pipeline stage X in pipeline cycle 1, the result of stage X processing is transferred to pipeline stage B for further processing in pipeline cycle 2. Thus, the first pipeline cycle is directly followed by the second pipeline cycle, which is directly followed by a third pipeline cycle, etc.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

An H.264 compliant video encoder subdivides each video frame into a set of macroblocks, encodes the macroblocks, and packs the encoded macroblocks into a video bitstream. The H.241 recommendation specifies packetization of the video bitstream for transmission and/or storage. H.241 requires that the encoded bitstream be divided into constant sized packets (i.e. slices) each including an integer number of macroblocks.

For optimum efficiency, each slice should contain as many macroblocks as possible. Unfortunately, the number of bytes of a macroblock to be inserted in a slice cannot be determined until the macroblock is fully encoded. Consequently, only after a macroblock is fully encoded can it be determined whether a current slice has sufficient available capacity to support inclusion of the macroblock. Some H.264 macroblock encoding techniques are slice dependent. Therefore, if a macroblock was originally encoded with reference to a current slice and later determined to be too large for insertion in the current slice, the video encoder may re-encode the macroblock with reference to a new slice.

Video encoders may be deeply pipelined to optimize throughput. When a macroblock is re-encoded for insertion in a new slice, the encoding pipeline is disrupted and encoder performance is reduced. In some video encoding systems, re-encoding macroblocks may absorb a substantial portion (e.g., over 10%) of encoder capacity.

Embodiments of the present disclosure manage the video encoding pipeline to reduce the number of pipeline cycles lost when a macroblock is re-encoded due to a slice break, thereby improving overall video encoder performance.

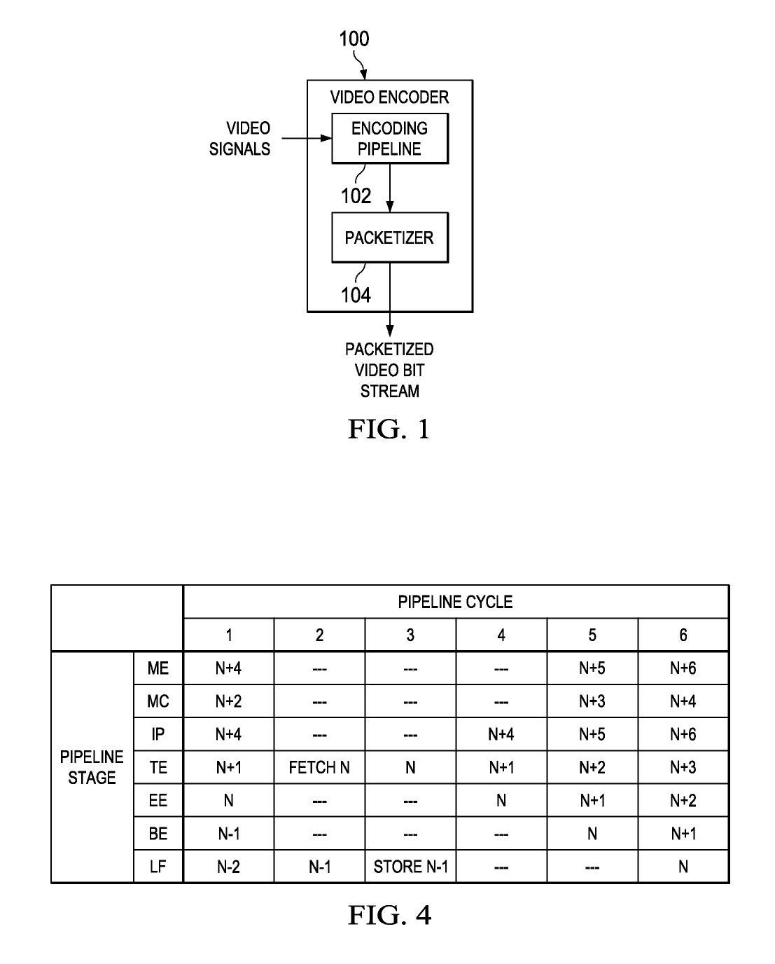

FIG. 1 shows a block diagram of a video encoding system 100 in accordance with various embodiments. The video encoding system 100 includes an encoding pipeline 102 and a packetizer 104. The encoding pipeline 102 receives video signals comprising frames of video, divides each frame in macroblocks (e.g., 16×16 pixel blocks), and encodes the macroblocks to reduce redundancy. Some embodiments of the encoding pipeline 102 process pairs of macroblocks (i.e., macroblock pairs) rather than individual macroblocks. References to a “macroblock” in the present disclosure are also pertinent to a macroblock pair. Embodiments of the encoding pipeline 102 include a plurality of function units arranged to provide a specified throughput for given received video signals. For example, an encoding pipeline configured to process thirty 1920×1080 high-definition video frames per second may be different from (e.g., deeper, different function units, etc.) an encoding pipeline configured to process thirty 640×480 video frames per second.

The packetizer 104 receives encoded macroblocks from the encoding pipeline 102, and inserts the encoded macroblocks into a packet or slice of predetermined maximum size. For example, a system configured to receive the video slices produced by the packetizer 104 may specify to the encoding system 100 a maximum number of bytes per slice. The packetizer 104 compares the number of bytes of an encoded macroblock with the number of available bytes in a current slice. A slice includes sequential macroblocks and may not include a partial macroblock. Therefore, if the packetizer 104 determines that an encoded macroblock is too large to be inserted in the current macroblock, a slice break occurs wherein the current slice is deemed complete, and the encoded macroblock will be the first macroblock of a new slice.

Because at least some H.264 encoding schemes require that a macroblock be encoded by reference to a slice containing the macroblock, the packetizer 104 causes the encoding pipeline 102 to re-encode a macroblock if the macroblock is too large for the current slice. Such re-encoding perturbs the encoding pipeline 102. In some systems, the entire encoding pipeline may be flushed and reloaded for each slice. Embodiments of the encoding pipeline 102 manage the function units to minimize the number of pipeline stages (i.e., function units) reloaded and to minimize retrieval of video signals from low-performance storage. Some embodiments of the encoding pipeline 102 restrict macroblock coding applied to some post slice break macroblock encoding based on invalidity or lack of coding predictions (e.g., inter or intra predictions) computed by the pipeline 102 prior to the slice break.

Some embodiments of the video encoding system 100 merge the packetizer 104 into one or more function units of the encoding pipeline 102. For example, the packetizer 102 may be included in an entropy encoding function unit of the encoding pipeline 102.

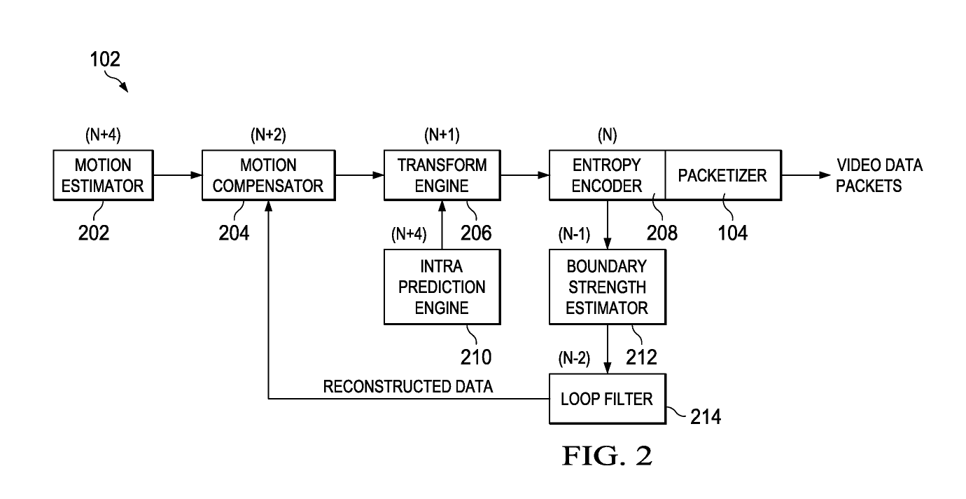

FIG. 2 shows a block diagram of a video encoding pipeline 102 in accordance with various embodiments. The pipeline 102 includes a motion estimator 202, a motion compensator 204, an intra prediction engine 210, a transform engine 206, an entropy encoder 208, a boundary strength estimator 212, and a loop filter 214. The packetizer 104 is also shown, and as explained above, is merged into the entropy encoder 208 in some embodiments.

The motion estimator 202 and the motion compensator 204 cooperate to provide macroblock inter frame predictions (i.e., temporal predictions). The motion estimator 202 generates a motion vector for a given macroblock based on a closest match for the macroblock in a previously encoded frame. The motion compensator 204 applies the motion vector produced by the motion estimator 202 to the previously encoded frame to generate an estimate of the given macroblock.

The intra prediction engine 210 analyzes a given macroblock with reference to a macroblock directly above (i.e., upper) and a macroblock immediately to the left of, and in the same frame as, the given macroblock to provide spatial predictions. Based on the analysis, the intra prediction engine 210 selects one of a plurality of intra prediction modes provided by H.264 for application to the given macroblock.

The transform engine 206 determines whether a given macroblock is to be inter or intra coded, applies frequency transformation to macroblock residuals, and quantizes coefficients resulting from frequency transformation. The transform engine 206 computes a first set of residuals as the difference of the inter predicted macroblock provided from the motion compensator 204 and the given macroblock. The transform engine 206 also computes a intra predicted macroblock based on the reconstructed left and upper macroblocks and the intra prediction mode estimate provided from the intra prediction engine 210, and computes a second set of residuals as the difference of the intra predicted macroblock and the given macroblock. If inter prediction produces lower residuals than intra prediction, given macroblock will be inter coded. If intra prediction produces lower residuals than inter prediction, given macroblock will be intra coded.

The entropy encoder 208 receives the quantized transformed residuals, and applies one of context adaptive binary arithmetic coding and context adaptive variable length coding to produce an entropy encoded macroblock. The entropy encoded macroblock is provided to the packetizer 104 for insertion is a slice.

The boundary strength estimator 212 assigns strength values to the edges of the 4×4 or 8×8 transform blocks of each macroblock inserted in a slice. The strength values may be determined based, for example, on inter-block luminance gradient, size of applied quantization step, and difference in applied coding.

The loop filter 214 receives the strength values provided from the boundary strength estimator 212 and filters the transform block edges in accordance with the values. Each filtered macroblock is stored for use by the motion estimator 202 and the motion compensator 204 in inter prediction.

In association with each of the function units 202-214, a parenthetical is shown in FIG. 2. Each parenthetical specifies a macroblock being processed by the functional unit with the pipeline 102 in steady state. Thus, when the entropy encoder 208 is processing a first macroblock (N), the transform processor is processing a second macroblock (N+1), the motion compensator 204 is processing a third macroblock (N+2), and the motion estimator 202 and intra prediction engine 210 are processing a fifth macroblock (N+4), etc. The entropy encoder 208 encodes macroblock (N) and provides the encoded macroblock (N) to the packetizer 104 for insertion in the current slice. If the packetizer 104 determines that the current slice has insufficient available capacity to allow insertion of the encoded macroblock (N), then the current slice is complete, and a new slice is started. Unfortunately, the encoded macroblock (N) may be unsuitable for insertion in the new slice because H.264 encoding requires that intra prediction be based only on macroblocks within the same slice. Consequently, macroblock (N) is reprocessed prior to insertion in the new slice. Macroblocks (N−1) and (N−2) in the boundary strength estimator 212 and loop filter 214 are included in the current slice, and are therefore unaffected by the slice break at macroblock (N).

In contrast to embodiments of the present disclosure, in a straightforward implementation of an encoding pipeline (as explained with reference to the pipeline 102 of FIG. 2), after the slice break at macroblock (N), macroblocks (N−2) and (N−1) are drained from the pipeline in the next two pipeline cycles, the pipeline is cleared, and in the six succeeding pipeline cycles the pipeline is refilled to the point where macroblock (N) is again being entropy coded and is inserted as the first macroblock of a new slice. Such operation requires an additional eight pipeline cycles per slice break. If processing 1920×1088 high definition video frames, a pipeline operating in such a manner must process at least 8 additional macroblock pairs per row, resulting in 1088 additional macroblocks per frame.

Embodiments of the pipeline 102 provide improved slice break performance. Embodiments of the pipeline 102 are not cleared and refilled in response to a slice break. Instead, responsive to a slice break, macroblock reprocessing overrides normal pipeline flow while minimizing accesses to slower storage resources. Macroblocks are reprocessed in accordance with restrictions resulting from the requirements of H.264 and the results of processing performed prior to the slice break. Consequently, embodiments of the pipeline 102 require no more than three additional pipeline cycles per slice break to reprocess the macroblock (N).

Some of the function units 202-214 of the pipeline 102 may be implemented as one or more processors executing instructions retrieved from a computer-readable medium. In some embodiments, some of the function units 202-214 may implemented as dedicated circuitry configured to perform the functions herein ascribed to the function unit.

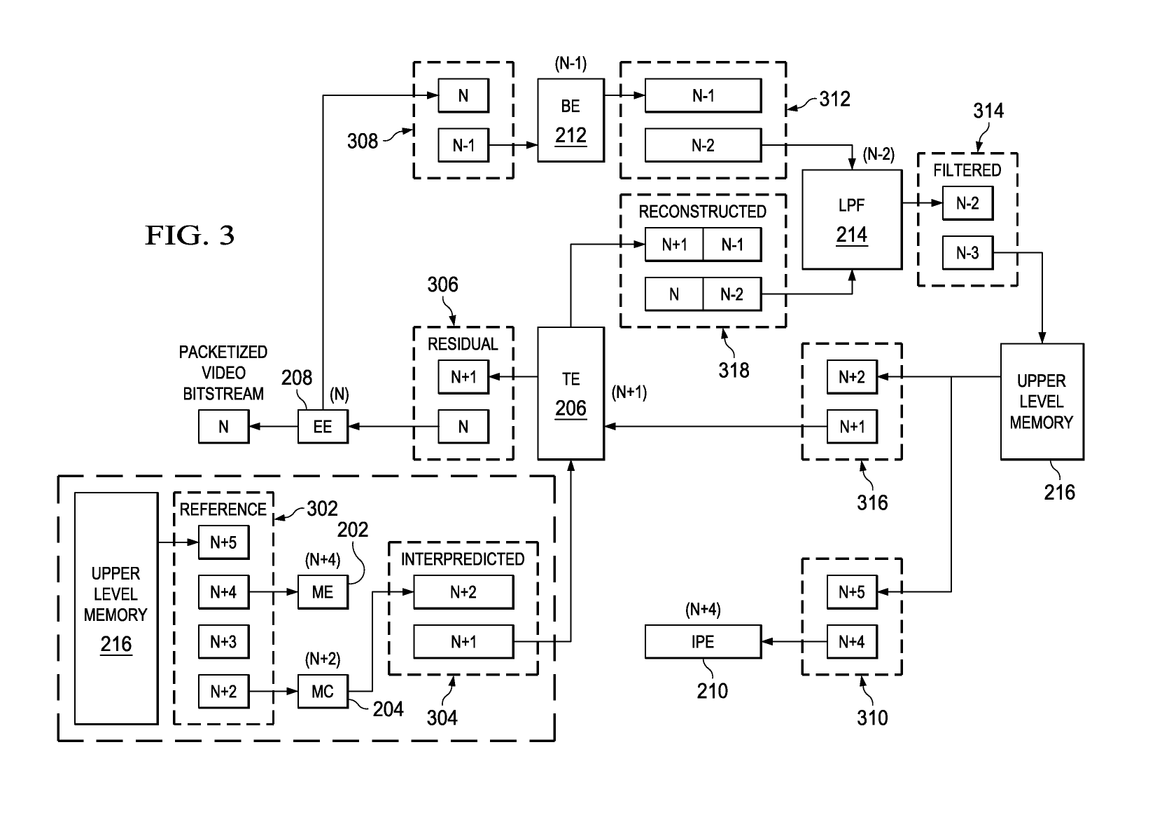

Operation of various embodiments is now explained by reference to FIGS. 3-4. FIG. 3 shows a block diagram of a video encoding pipeline 102 with the memory buffers associated with each function unit of a video encoder 100 in accordance with various embodiments. A local memory buffer 302-318 is associated with each function unit 202-214. Some embodiments implement double buffering in the local memory buffers 302-318 as shown in FIG. 3. Some embodiments implement triple buffering. Each function unit may use a direct memory access (“DMA”) channel to move macroblock data to and/or from a local memory buffer to an upper level memory 216. As in FIG. 2, the encoding pipeline 102 of FIG. 3 is shown in steady state with macroblock (N) in the entropy encoder 208. FIG. 4 shows operations of the video encoder pipeline 102 responsive to a slice break condition in accordance with various embodiments. More specifically, FIG. 4 shows the macroblocks operated on by each function unit in each pipeline cycle after a slice break.

In pipeline cycle 1 shown in FIG. 4, the encoding pipeline 102 is in steady as shown in FIG. 3. The entropy encoder 208, which incorporates the packetizer 104, determines that the encoded macroblock (N) is too large to be inserted in the available portion of the current slice, and thus the current slice is complete. Based on this determination, the entropy encoder 208 informs the remaining function units 202-206, 210-214 to initiate slice break recovery beginning in the next pipeline cycle.

In pipeline cycle 2 shown in FIG. 4, only the transform engine 206 and the loop filter 214 are active. The loop filter is processing macroblock (N−1). As explained above, macroblocks (N−2) and (N−1) are unaffected by the slice break. The transform engine 206 is retrieving (e.g., via DMA) the macroblock (N) from upper level memory 216. In some embodiments, the pipeline cycle 2 will be much shorter than the pipeline cycle 1 or other pipeline cycles where encoding system 100 resources (e.g., memory bandwidth, processor bandwidth, etc.) are more heavily loaded.

In pipeline cycle 3, shown in FIG. 4, again only the transform engine 206 and the loop filter 214 are active. The loop filter is transferring macroblock (N−1) to upper level memory (e.g., via DMA). The transform engine 206 is reprocessing macroblock (N) and retrieving macroblock (N+1). In some embodiments, the transform engine 206 codes macroblock (N) using intra prediction mode DC because neither a left nor an upper macroblock is available in the new slice as required by other H.264 intra prediction modes, and the inter predicted macroblock (N) is not available in the local memory buffer 304. In embodiments in which the local memory buffer 304 implements triple buffering, the transform engine 206 may apply inter coding because the inter predicted macroblock (N) is available. The transform engine retransforms and requantizes macroblock (N) and stores the quantized macroblock (i.e., the residual) in local memory buffer 306. In some embodiments of the encoding pipeline 102, the intra prediction engine 210 may be restarted to process macroblock (N+3) for future use by the transform engine 206.

In pipeline cycle 4, shown in FIG. 4, the entropy encoder 208, transform engine 206, and intra prediction engine 210 are active. The entropy encoder 208 is encoding the macroblock (N) and inserting the encoded macroblock (N) as the first macroblock of the new slice. Thus, the slice break in pipeline cycle 1 requires three pipeline cycles for recovery. The transform engine 206 is processing macroblock (N+1) and retrieving macroblock (N+2). The transform engine 206 may code the macroblock (N+1) as inter because the inter predicted macroblock (N−1) computer prior to the slice break is available in the local memory buffer 304. If the transform engine 206 codes the macroblock (N+1) as intra, the transform engine 206 may restrict the intra coding to use of the left macroblock, and may not use an upper macroblock because no upper macroblock is available in the new slice. The intra prediction engine 210 processes the macroblock (N+4) to estimate an intra prediction mode for future use by the transform processor 206.

In pipeline cycle 5, shown in FIG. 4, the boundary strength estimator 212, the entropy encoder 208, transform engine 206, the intra prediction engine 210, the motion compensator 204, and the motion estimator 202 are active. The boundary strength estimator is determining boundary strength values for the macroblock (N). The entropy encoder 208 is encoding the macroblock (N+1) and inserting the encoded macroblock (N+1) in the new slice. The transform engine 206 is processing macroblock (N+2) and retrieving macroblock (N+3). The transform engine may restrict intra prediction applied to the macroblock (N+2) as described above with regard to the macroblock (N+1). The intra prediction engine 210 processes the macroblock (N+5) to estimate an intra prediction mode for future use by the transform processor 206. The motion compensator 204 is computing inter predicted macroblock (N+3). The motion estimator 202 is determining a motion vector for macroblock (N+5).

In pipeline cycle 6, shown in FIG. 4, the encoding pipeline 102 is again full. However, the transform engine 206 may restrict intra prediction applied in cycle 6 and successive cycles based on when the intra prediction engine 210 was restarted (i.e., when intra prediction mode estimates based on the new slice are available). While intra prediction mode estimates based on the new slice are not available, the transform engine 206 will restrict the intra prediction applied to a macroblock as described above with regard to the macroblock (N+1).

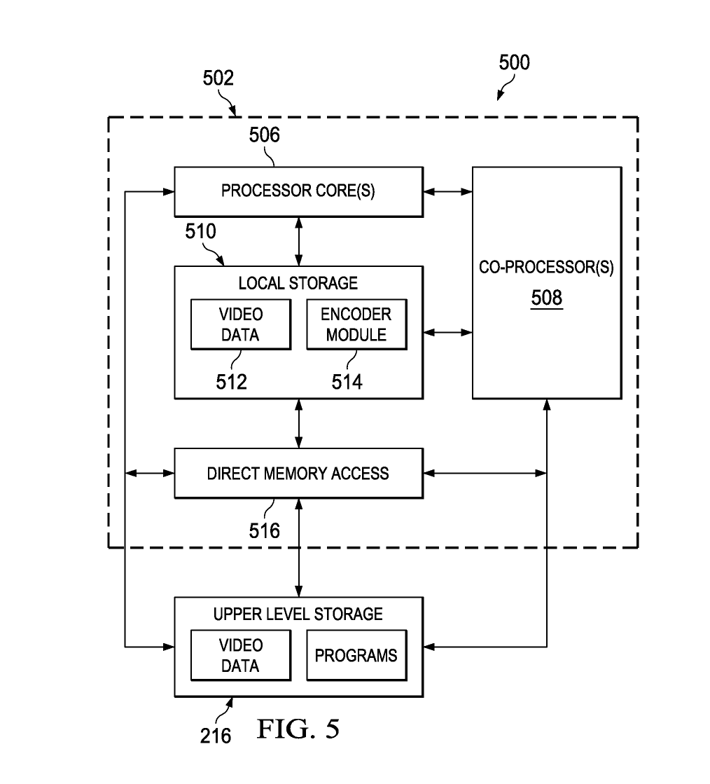

FIG. 5 shows a block diagram of a processor based system 500 for encoding video in accordance with various embodiments. The system 500 includes a processor 502 and storage 504 coupled to the processor 502. The processor 502 may include one or more processor cores 506. In some embodiments, one or more of the processor cores 506 may be used to implement or control a function unit of the encoding pipeline 102. A processor core 506 suitable for implementing a function unit of the encoding pipeline 102 and/or for controlling operations of the function units may be a general-purpose processor core, digital signal processor core, microcontroller core, etc. Processor core architectures generally include execution units (e.g., fixed point, floating point, integer, etc.), storage (e.g., registers, memory, etc.), instruction decoding, data routing (e.g., buses), etc.

The processor 502 may also include specialized coprocessors 508 or dedicated hardware circuitry coupled to the processor core(s) 506. The coprocessors 508 may be configured to accelerate operations performed by a function block of the encoding pipeline 102. For example, a specialized coprocessor 508 may be included to accelerate context-based adaptive arithmetic coding or frequency domain transformation.

Local storage 510 is coupled to the processor core(s) 506 and the coprocessor(s) 508. The local storage 510 is a computer-readable medium from which program instructions and/or data (e.g., video data) may be accessed by the processor core(s) 506 and the coprocessor(s) 508. The encoder module 514 provided in local storage 510 includes instructions that when executed cause the processor core(s) 506 and/or the coprocessor(s) 508 to perform or control the operations of the function units of the encoding pipeline 102. The video data 512 may include the local memory buffers 302-318 storing macroblocks being processed by the encoding pipeline 102. The local storage may be semiconductor memory (e.g., static random access memory (“SRAM”)) closely coupled to the processor core(s) 506 and the coprocessor(s) 508 and configured for quick access (e.g., single clock cycle access) thereby.

A DMA system 516 may provide one or more DMA channels for moving data (e.g., video data) between local storage 510 and upper level storage 504, within storage 504, 510, between storage 504, 510 and a peripheral (e.g., a communication system), etc. In embodiments of the encoding pipeline 102, DMA channels are assigned to various ones of the function units of the pipeline. For example, DMA channels may be assigned to the transform engine 206, the loop filter 214, the intra prediction engine, 210, the motion estimator 202, and the motion compensator 204 for movement of macroblocks into and/or out of the associated local memory buffers 302-316.

The processor 502 may also include peripherals (e.g., interrupt controllers, timers, clock circuitry, etc.), input/output systems (e.g., serial ports, parallel ports, etc.) and various other components and sub-systems.

The upper level storage 216 may be external to the processor 502 and provide storage capacity not available on the processor 502. The upper level storage 216 may store programs (e.g., a video encoding program) and data (e.g., processed or unprocessed video data) for access by the processor 502. The upper level storage is a computer-readable medium that may be coupled to the processor 502. Exemplary computer-readable media appropriate for use as the upper level storage 216 include volatile or non-volatile semiconductor memory (e.g., FLASH memory, static or dynamic random access memory, etc.), magnetic storage (e.g., a hard drive, tape, etc.), optical storage (e.g., compact disc, digital versatile disc, etc.), etc.

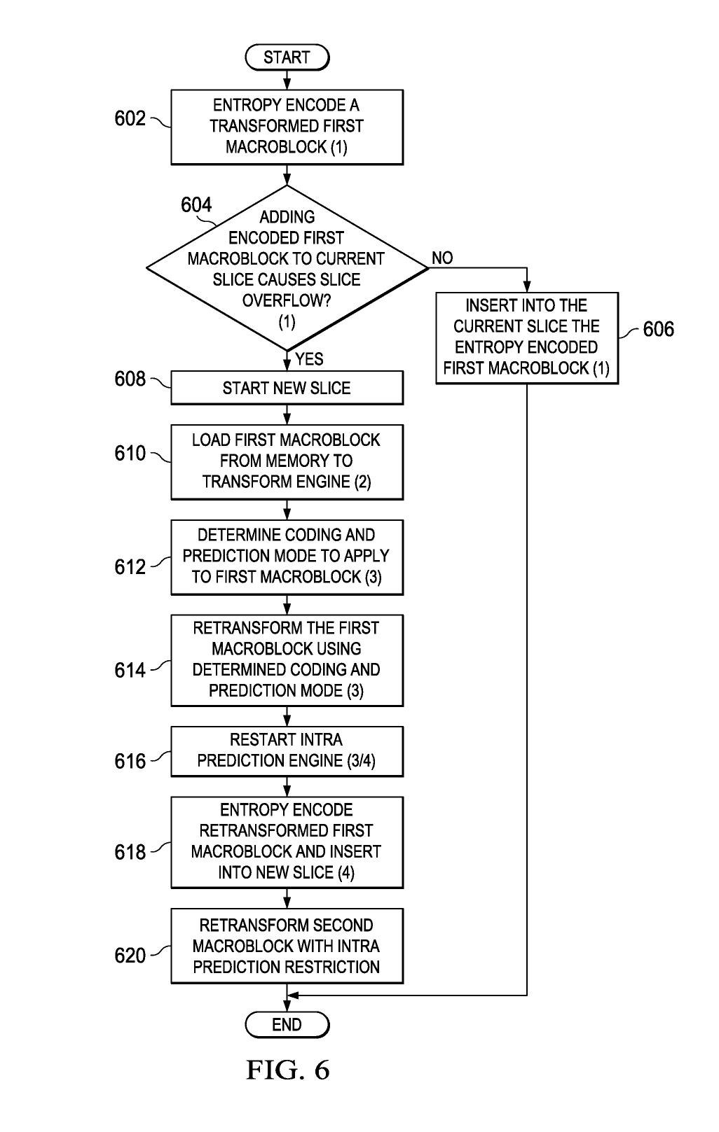

FIG. 6 shows a flow diagram for a method of encoding video responsive to a slice break condition in accordance with various embodiments. Though depicted sequentially as a matter of convenience, at least some of the actions shown can be performed in a different order and/or performed in parallel. Additionally, some embodiments may perform only some of the actions shown. In some embodiments, the operations of FIG. 6, as well as other operations described herein, can be implemented as instructions stored in a computer-readable medium (e.g., storage 514, 216) and executed by processing circuitry (e.g., processor(s) 502, coprocessor(s) 508, etc.).

In block 602, the encoding pipeline 102 is processing video macroblocks, and packetizing the encoded macroblocks. In a first pipeline cycle, the entropy encoder 208 encodes a first transformed macroblock (N). The entropy encoder 208 may apply arithmetic coding or Huffman coding in accordance with H.264.

In block 604, the entropy encoder 208, which incorporates the packetizer 104, determines whether adding the encoded first macroblock (N) to the current slice will cause a slice overflow, i.e., whether the current slice has sufficient available capacity to include the encoded macroblock (N). The operations of block 604 are performed in the first pipeline cycle.

If the entropy encoder 208 determines that adding the encoded first macroblock (N) to the current slice will not cause a slice overflow, then the encoded first macroblock is inserted into the current slice in block 606 and pipelined processing continues. The operations of block 606 are performed in the first pipeline cycle.

If the entropy encoder 208 determines that adding the encoded first macroblock (N) to the current slice will cause a slice overflow, then the encoded first macroblock is not inserted into the current slice. Instead, the current slice is deemed complete, and a new slice is initiated, in block 608. Responsive to the slice break, the function units of the encoding pipeline 102 are configured to initiate slice break recovery processing on the next pipeline cycle (i.e., pipeline cycle 2) and create a new slice.

In block 610, the transform engine 206 reloads the first macroblock (N) for processing. The first macroblock will be reprocessed to enforce coding restrictions of H.264 (e.g., intra prediction must be slice relative). The operations of block 610 are performed in the second pipeline cycle (i.e., the pipeline cycle immediately following pipeline cycle 1). Encoding system 100 resource use is low in pipeline cycle 2, consequently, pipeline cycle 2 may be substantially shorter than a pipeline cycle occurring when the encoding pipeline 102 is in steady state or otherwise more heavily loaded.

In block 612, the transform engine determines the coding to be applied to the first macroblock (N), and determines the prediction mode to be applied to the first macroblock (N). In some embodiments, the transform engine reprocesses the first macroblock using intra coding and DC prediction mode because no inter prediction data is available in the local memory buffer 304, and neither upper nor left neighboring macroblock is available in the new slice. In embodiments where inter prediction data is available, inter coding may be applied to reprocessing the first macroblock (N). The operations of block 612 are performed in the third pipeline cycle (i.e., pipeline cycle 3, the pipeline cycle immediately following pipeline cycle 2).

In block 614, the transform engine applies the coding and intra prediction mode selected in block 612, and performs frequency transformation and quantization. The operations of block 614 are performed in the third pipeline cycle.

In block 616, the encoding pipeline 102 restarts the intra prediction engine 210 to produce intra prediction mode estimates for use by the transform engine 206 in processing later macroblocks. In some embodiments, the intra prediction engine 210 is restarted in the third pipeline cycle. In some embodiments, the intra prediction engine 210 is restarted in fourth pipeline cycle (i.e., the pipeline cycle immediately following pipeline cycle 3).

In block 618, the entropy encoder 208 re-encodes the first macroblock (N) as retransformed by the transform engine 206 in block 614. The re-encoded first macroblock is inserted in the new slice as the first macroblock of the slice. The operations of block 618 are performed in the fourth pipeline cycle.

In block 620, the transform engine 206 determines a coding and prediction mode to apply to the second macroblock (N+1). In some embodiments, inter coding may be applied because the buffer 304 includes an inter prediction for the second macroblock (N+1) computed prior to the slice break. In some embodiments, if the transform engine selects intra coding, then intra prediction may not use an upper neighbor macroblock because the upper neighbor belongs to the previous slice. The operations of block 620 are performed in the fourth pipeline cycle.

In some embodiments, the transform engine 206 will restrict the intra prediction applied to up to a third, fourth, or fifth macroblock in the same manner as described above with regard to the second macroblock (N+1). The number of macroblocks so restricted by the transform engine 206 may be determined based on when the intra prediction engine 210 is restarted and provides intra prediction mode estimates accounting for the slice break. For example, if the intra prediction engine 210 is restarted to process macroblock (N+3) in the third pipeline cycle, then the transform engine 206 may be configured to restrict the intra prediction mode applied to the first, second, and third macroblocks (N through N+2). Restarting the intra prediction engine 210 in a later pipeline cycle results in correspondingly more macroblocks for which the transform engine 206 must restrict the intra prediction mode.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A video encoder, comprising:
an multi-stage encoding pipeline comprising:
an entropy coding engine configured to, in a first pipeline cycle, entropy encode a transformed first macroblock and determine that adding the entropy encoded macroblock to a slice causes the slice to exceed a predetermined maximum slice size; and
a transform engine configured to:
provide a transformed macroblock to the entropy coding engine; and
determine, in a third pipeline cycle, coding and prediction mode to apply to the first macroblock, based on the entropy coding engine determining, in the first pipeline cycle, that adding the entropy encoded macroblock to the slice causes the slice to exceed the predetermined maximum slice size.

2. The video encoder of claim 1, wherein the transform engine is configured to transform the first macroblock, in the third pipeline cycle, using the determined coding and prediction mode.

3. The video encoder of claim 1, wherein the transform engine is configured to select intra coding for application to the first macroblock in the third pipeline cycle.

4. The video encoder of claim 1, wherein the transform engine is configured to retrieve the first macroblock from memory in a second pipeline cycle.

5. The video encoder of claim 1, wherein the pipeline further comprises a motion estimator and a motion compensator disposed at pipeline stages ahead of the transform engine, wherein, after the first pipeline cycle in which the entropy coding engine determines that the predetermined maximum slice size will be exceeded by adding the encoded macroblock to a slice, the motion estimator and the motion compensator reprocess no macroblocks processed prior to or during the first pipeline cycle.

6. The video encoder of claim 1, wherein the pipeline further includes an intra prediction engine disposed at a pipeline stage ahead of the transform engine and after the first pipeline cycle in which the entropy coding engine determines that the predetermined maximum slice size will be exceeded by adding the encoded macroblock to a slice, the intra prediction engine reprocesses one of a fourth macroblock during the third pipeline cycle and a fifth macroblock during a fourth pipeline cycle.

7. The video encoder of claim 1, wherein the entropy coding engine determining that the predetermined maximum slice size will be exceeded by adding the entropy encoded macroblock to the slice delays output of the first macroblock to a new slice by fewer than four pipeline cycles.

8. The video encoder of claim 1, wherein the transform engine is configured to determine, in a fourth pipeline cycle, a coding and prediction mode to apply to a second macroblock, based on the entropy coding engine determining, in the first pipeline cycle, that the predetermined maximum slice size will be exceeded by adding the encoded macroblock to a slice; wherein the coding is one of inter, and intra without prediction using a top neighbor macroblock.

9. A method, comprising:
applying, by processing circuitry, entropy coding to a transformed first macroblock in a first pipeline cycle;
determining, by the processing circuitry, in the first pipeline cycle, that a predetermined maximum slice size will be exceeded by adding the entropy encoded macroblock to a slice;
determining, by the processing circuitry, in a third pipeline cycle, a coding and prediction mode to apply to the first macroblock, based on the determining in the first pipeline cycle; and
retransforming, by the processing circuitry, the first macroblock using the coding and prediction mode.

10. The method of claim 9, further comprising selecting intra coding from a plurality of available codings to apply to the first macroblock in the retransforming.

11. The method of claim 9, further comprising retrieving the first macroblock from memory in a second pipeline cycle.

12. The method of claim 9, further comprising reprocessing no macroblocks for motion estimation or motion compensation that were processed prior to or during the first pipeline cycle.

13. The method of claim 9, further comprising performing intra prediction estimation for one of a fourth macroblock during a third pipeline cycle and a fifth macroblock during a fourth pipeline cycle.

14. The method of claim 9, further comprising entropy encoding the retransformed first macroblock in a fourth pipeline cycle and providing the entropy encoded retransformed first macroblock as the first macroblock of a new slice.

15. A computer readable medium encoded with a computer program that when executed causes processing circuitry to:
apply entropy coding to a transformed first macroblock in a first pipeline cycle;
determine, in the first pipeline cycle, that a predetermined maximum slice size will be exceeded by adding the entropy encoded macroblock to a slice;
determine, in a third pipeline cycle, a coding and prediction mode to apply to the first macroblock, based on the determining in the first pipeline cycle; and
retransform the first macroblock using the coding and prediction mode.

16. The computer readable medium of claim 15, wherein the program causes the processing circuitry to restrict coding applied when retransforming the first macroblock to intra coding.

17. The computer readable medium of claim 15, wherein the program causes the processing circuitry to retrieve the first macroblock from memory in a second pipeline cycle.

18. The computer readable medium of claim 15, wherein the program configures a motion estimation engine and a motion compensation engine to reprocess no macroblocks processed prior to or during the first pipeline cycle.

19. The computer readable medium of claim 15, wherein the program configures an intra prediction engine to reprocess one of a fourth macroblock during a third pipeline cycle and a fifth macroblock during a fourth pipeline cycle.

20. The computer readable medium of claim 15, wherein the program causes the processing circuitry to entropy encode the retransformed first macroblock in a fourth pipeline cycle and provide the entropy encoded retransformed first macroblock as the first macroblock of a new slice.

21. A video system, comprising:
a video encoder that encodes video data; and
a packetizer that partitions encoded video data into packets;
wherein the packetizer is configured to:
receive a first entropy encoded macroblock; and
determine, in a first encoder pipeline cycle, whether a predetermined maximum packet size will be exceeded by adding the first entropy encoded macroblock to a first packet;
wherein the video encoder comprises:
a transform engine pipeline stage configured to determine, in a third encoder pipeline cycle, coding and prediction mode to apply to the first macroblock, based on the packetizer determining, in the first pipeline cycle, that the predetermined maximum packet size will be exceeded by adding the first entropy encoded macroblock to the first packet; and
an entropy encoder pipeline stage configured to entropy encode a transformed macroblock produced by the transform engine, and provide the entropy encoded macroblock to the packetizer.

22. The video system of claim 21, wherein the transform engine pipeline stage is configured to generate a retransformed first macroblock in the third pipeline cycle, and the entropy encoder pipeline stage is configured to entropy encode the retransformed first macroblock in a fourth pipeline cycle, and the packetizer is configured to insert the entropy encoded retransformed first macroblock as the first macroblock of a second packet in the fourth pipeline cycle.

23. The video system of claim 22, wherein the transform engine pipeline stage is configured to restrict coding applied in the third pipeline cycle to intra coding.

24. The video system of claim 21, wherein the transform engine pipeline stage is configured to retrieve the first macroblock from memory in a second pipeline cycle.

25. The video system of claim 21, wherein the video encoder further comprises:
a motion compensation pipeline stage disposed ahead of the transform engine pipeline stage; and
a motion estimation pipeline stage disposed ahead of the motion compensation pipeline stage;
wherein the motion estimation and motion compensation pipeline stages are configured to reprocess no macroblocks processed prior to or during the first pipeline cycle after the packetizer determines that the predetermined maximum packet size will be exceeded by adding the first entropy encoded macroblock to the first packet.

26. The video system of claim 21, wherein the video encoder further comprises:
an intra prediction engine pipeline stage disposed ahead of the transform engine pipeline stage;
wherein the intra prediction engine is configured to reprocess one of a fourth macroblock during the third pipeline cycle and a fifth macroblock during a fourth pipeline cycle after the packetizer determines that the maximum predetermined packet size will be exceeded by adding the first entropy encoded macroblock to the first packet.

27. The video system of claim 21, wherein the packetizer adds a retransformed first macroblock to a second packet less than four pipeline cycles after the packetizer determines that the predetermined maximum packet size will be exceeded by adding the first entropy encoded macroblock to the first packet.
